(19) United States
(12) Patent Application Publication
(10) Pub. No.: US 2022/0032685 A1
(43) Pub. Date: Feb. 3, 2022

(54) BICYCLE HUB STRUCTURE

(71) Applicant: YU-SHAN HUANG, Changhua City (TW)

(72) Inventor: YU-SHAN HUANG, Changhua City (TW)

(21) Appl. No.: 16/945,919

(22) Filed: Aug. 2, 2020

(51) Int. Cl. B60B 27/02; B60B 27/00; B60B 27/04

(52) U.S. Cl. CPC B60B 27/023; B60B 27/047; B60B 27/0015

(57) ABSTRACT

A bicycle hub structure has a hub seat, an interlocking ring, a chainring seat, a shaft sleeve and a one-way bearing. The assembling space of the hub seat is installed with the interlocking ring by screw locking, and the chamber of the chainring seat is also screwed with the shaft sleeve. In particular, the inner surface of the interlocking ring and the control section of the shaft sleeve have been treated with special surface treatments to strengthen the hardness, which not only retaining the lightweight effect of the hub seat and the chainring seat and locally increasing the strength and hardness of the structure to avoid being scratched and worn by the one-way bearing. As result, a more stable transmission state is achieved and the durability of the structure is improved.

### BACKGROUND OF INVENTION

### Field of Invention

The present invention relates to a bicycle structure, and more particularly to a bicycle hub structure.

### Description of Related Art

Accordingly, common bicycles are equipped with a hub structure, and the hub structure is designed to form a unidirectional driving effect to prevent the wheels from driving the pedals in the reverse direction for more smoothly riding. The conventional hub structure includes a hub seat and a chainring seat, and a one-way bearing is installed between the hub seat and the chainring seat. The forward and reverse rotation of the chainring seat changes the engagement with the one-way bearing, and the hub seat is connected to drive the wheels to rotate or to idle. However, the current bicycle parts are made of aluminum alloy in order to reduce the weight. The aluminum alloy material is soft and easily deformed by impact, the long time friction among the hub seat, the chainring seat, and the one-way bearing can cause wear and damage. To ensure the stability of power transmission and riding safety, the hub seat or the chainring seat must be replaced regulaily. However, the hub seat and the chainring seat are both integrally formed together and cannot be replaced separately, resulting in increased replacement costs and lack of economic benefits.

Therefore, it is desirable to provide a bicycle hub structure to mitigate and/or obviate the aforementioned problems.

### SUMMARY OF INVENTION

An objective of present invention is to provide a bicycle hub structure, which is capable of improving the above-mention problems.

In order to achieve the above mentioned objective, a bicycle hub structure A bicycle hub structure has a hub seat, an interlocking ring, a chainring seat, a shaft sleeve and a one-way bearing. The assembling space of the hub seat is installed with the interlocking ring by screw locking, and the chamber of the chainring seat is also screwed with the shaft sleeve. In particular, the inner surface of the interlocking ring and the control section of the shaft sleeve have been treated with special surface treatments to strengthen the hardness, which not only retaining the lightweight effect of the hub seat and the chainring seat and locally increasing the strength and hardness of the structure to avoid being scratched and worn by the one-way bearing. As result, a more stable transmission state is achieved and the durability of the structure is improved.

Other objects, advantages, and novel features of invention will become more apparent from the following detailed description when taken in conjunction with the accompanying drawings.

### BRIEF DESCRIPTION OF DRAWINGS

FIG. 1 is a three-dimensional drawing according to a preferred embodiment of the present invention.

FIG. 2 is an exploded view according to the preferred embodiment of the present invention.

FIG. 3 is a partial cross-sectional view according to the preferred embodiment of the present invention.

FIG. 4 is a partial enlarged cross-sectional view according to the preferred embodiment of the present invention.

FIG. 5 is showing clockwise pedaling driving the hub seat to rotate via the one-way bearing joint according to the preferred embodiment of the present invention.

FIG. 6 is showing counterclockwise pedaling disengaging the hub seat via the one-way bearing to form an idling sliding state according to the preferred embodiment of the present invention.

### DETAILED DESCRIPTION OF PREFERRED EMBODIMENT

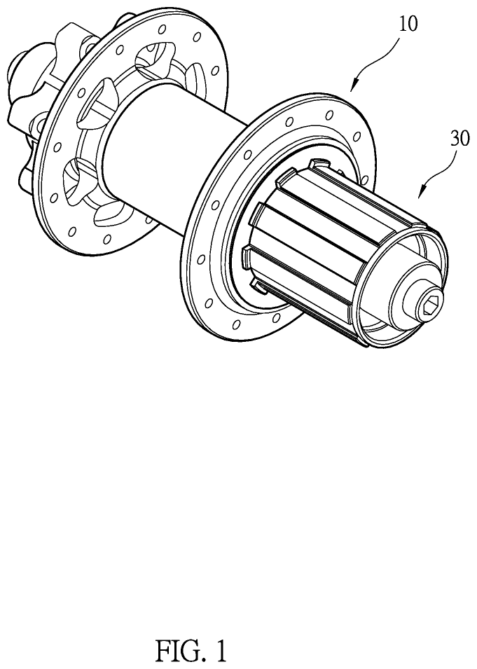

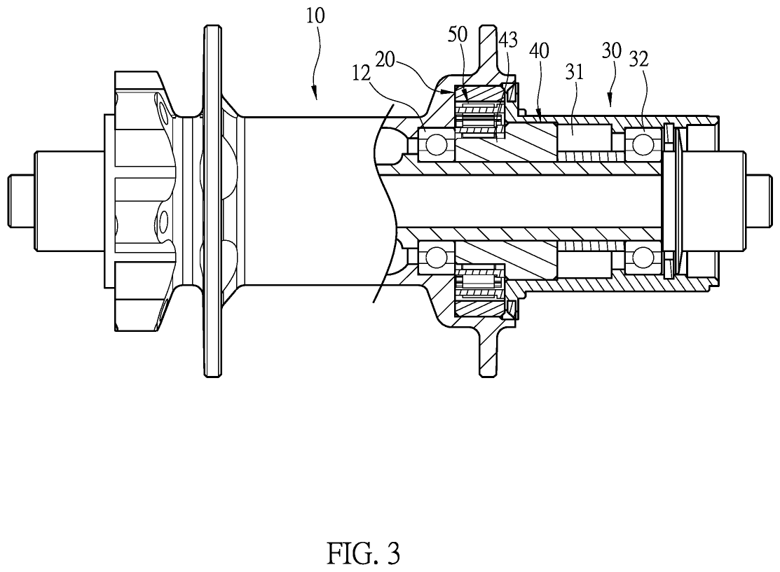

Please refer to FIGS. 1, 2 and 3, a bicycle hub structure comprises a hub seat 10, an interlocking ring 20, a chainring seat 30, a shaft sleeve 40 and a one-way bearing 50. The hub seat 10 has an assembling space 11, and the assembling space 11 comprises a bearing piece 12 and a shaft 13. An end of the shaft 13 extending out of the assembling space 11, and an opened end of the assembling space 11 has an inner threaded section 14. The interlocking ring 20 has an outer threaded section 21 corresponding to the inner threaded section 14 of the assembling space 11 and an inner surface 22 with a strengthening surface treatment. The chainring seat 30 has a chamber 31 assembled with a bearing piece 32 for connection with the shaft 13, and an opened end of the chamber 31 comprise an inner threaded section 33. The shaft sleeve 40 has a shaft hole 41 jacketing onto the shaft 13, a outer threaded section 42, and a control section 43 smaller than the outer threaded section 42 with a strengthening surface treatment. The one-way bearing 50 comprises an inner ring 51, an outer ring 52 and a plurality of engaging blocks 53 disposed between the inner and outer rings 51, 52. Furthermore, an elastic piece 54 is disposed between the inner and outer rings 51, 52, configured for restricting the engaging block 53. The one-way bearing 50 mounted between the inner surface 22 of the interlocking ring 20 and the control section 42 of the shaft sleeve 40.

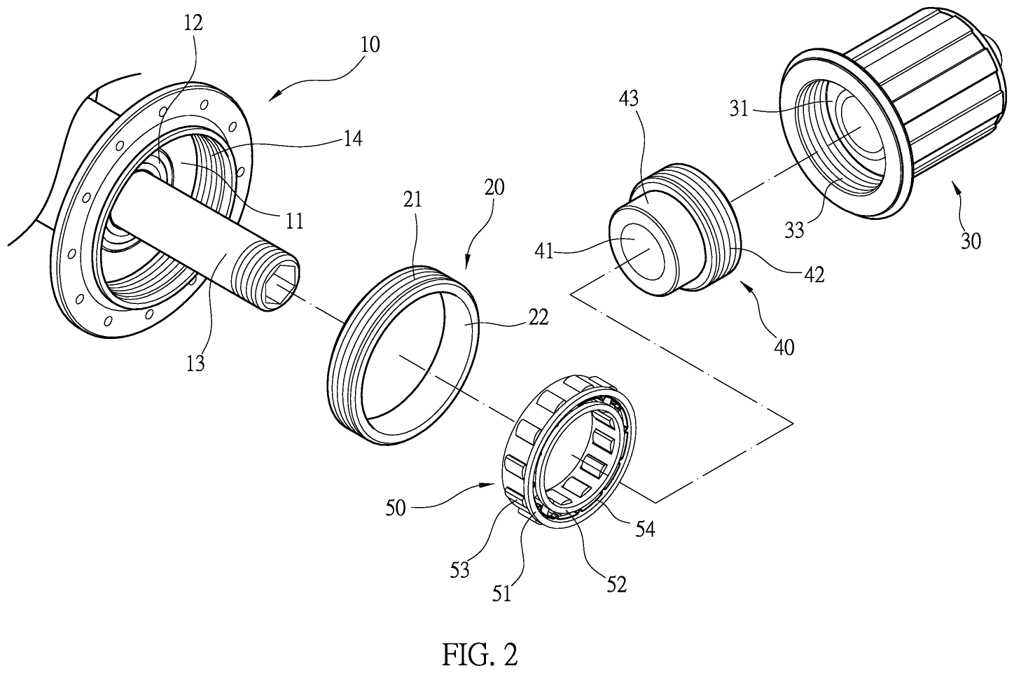

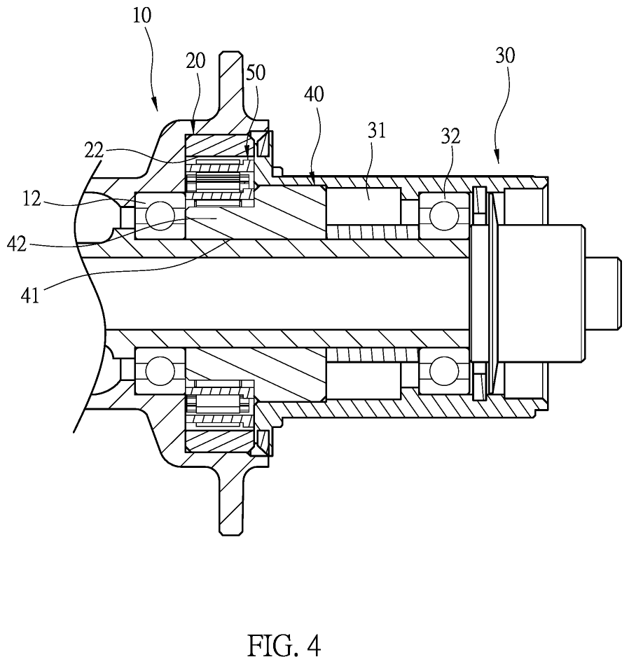

For structure assembly, please refer to FIGS. 2, 3 and 4. The outer threaded section 21 of the interlocking ring 20 is locked with the inner threaded section 14 of the assembling space 11 in the hub seat 10. The control section 43 of the shaft sleeve 40 faces outward and the outer threaded section 42 is locked with the inner threaded section 33 in the chamber 31 of the chainring seat 30. The chainring seat 30 and the hub seat 10 are combined together via the shaft sleeve 40 and the interlocking ring 20, and the one-way bearing 50 is mounted between the shaft sleeve 40 and the interlocking ring 20. The inner ends 531 of the engaging blocks of the one-way bearing 50 make contacts with the control section 43 of the shaft sleeve 40, causing the engaging blocks 53 driven by the control section 43 to rotate. And, the outer ends 532 of the engaging blocks 53 of the one-way bearing 50 pushes against the inner surface 22 of the interlocking ring 20, so the rotation direction of the chainring seat 30 controls the engagement between the shaft sleeve 40 and the interlocking ring 20. Furthermore, the chainring seat 40 utilizes the one-way bearing 50 to drive the hub seat 10 to rotate synchronously, and the shaft 13 of the hub seat 10 passes through the shaft hole 41 of the shaft sleeve 40, enters into the chainring seat 30 and engages with the bearing piece 32.

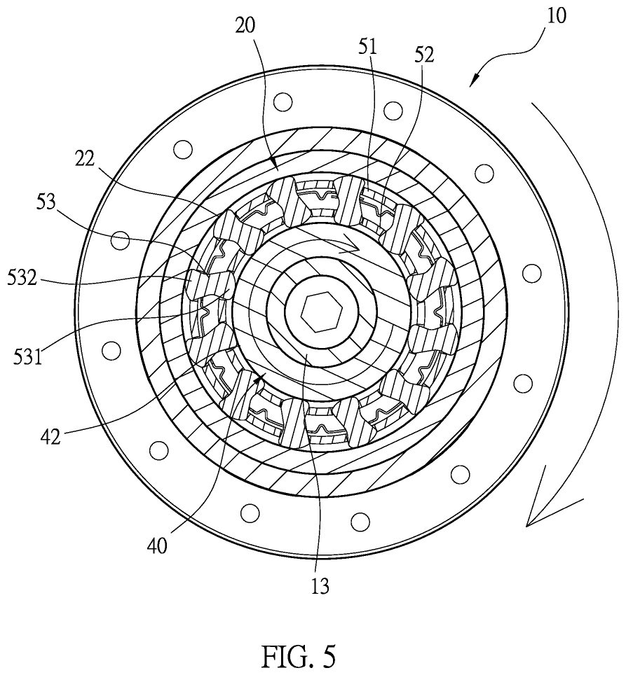

For actual use of the structure, please refer to FIG. 5. When the rider steps on the pedals to drive the chainring seat 30 to rotate in the forward direction to form a bicycle riding state. The shaft sleeve 40 utilizes the control section 43 to move the inner ends 531 of the engaging blocks 53 to make the outer ends 532 of the engaging blocks 53 to push against the inner surface 22 of the interlocking ring 20, such that the shaft sleeve 40 and the interlocking ring 20 are connected through the engaging blocks 53. Therefore, the chainring seat 30 is linked to the hub seat 10 through the one-way bearing 50 to form a synchronous action, and the hub seat 10 drives the wheels to rotate and move forward.

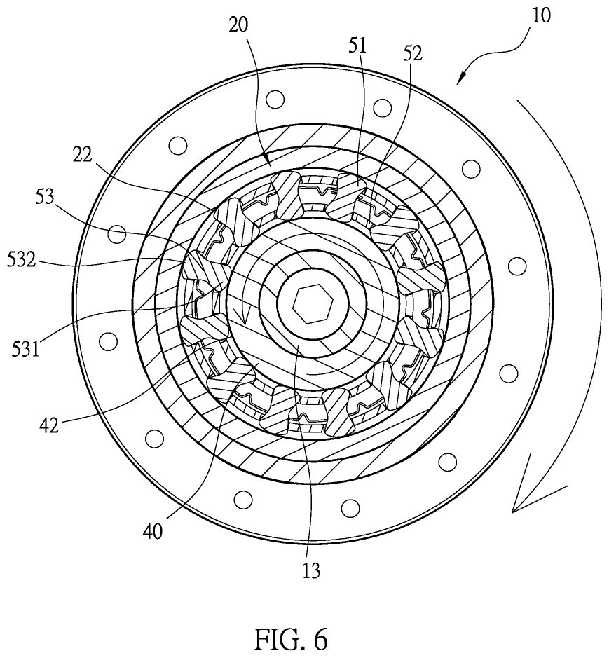

On the contrary, when the bicycle is riding forward the chainring seat 30 does not move or the when the user steps on the pedals backward to make the chainring seat 30 to reversely rotate, as shown in FIG. 6, the control section 43 of the sleeve 40 is in direct contact with the inner ends 531 of the engaging blocks 53 of the one-way bearing 50. When the shaft sleeve 40 stops rotating or rotates in the reverse direction, the interlocking ring 20 continuously being driven by the hub seat 10 to form a reverse rotation with the shaft sleeve 40, so that the outer ends 532 of the engaging blocks 53 are contacted by the interlocking ring 20 and then become detached. The engaging block 53 is further restricted by the elastic piece 54 to keep detached such that interlocking ring 20 and the one-way bearing 50 are in an idling state. As result, when the chainring seat 30 has no movement or rotates in the reverse direction, the hub seat 10 cannot be synchronized to rotate, only the chainring seat 30 and the bicycle chain are in idle connection, which forms the sliding state of the bicycle.

With the structure of the above specific embodiment, the following benefits can be obtained: the assembling space 11 of the hub seat 10 is installed with the interlocking ring 20 by screw locking, and the chamber 31 of the chainring seat 30 is also screwed with the shaft sleeve 40. In particular, the inner surface 22 of the interlocking ring 20 and the control section 43 of the shaft sleeve 40 have been treated with special surface treatments to strengthen the hardness, which not only retaining the lightweight effect of the hub seat 10 and the chainring seat 30 and locally increasing the strength and hardness of the structure to avoid being scratched and worn by the one-way bearing 50. As result, a more stable transmission state is achieved and the durability of the structure is improved.

Although the present invention has been explained in relation to its preferred embodiment, it is to be understood that many other possible modifications and variations can be made without departing from the spirit and scope of invention as hereinafter claimed.

What is claimed is:

1. A bicycle hub structure comprising:
a hub seat having an assembling space comprising a bearing piece and a shaft, an end of the shaft extending out of the assembling space, and an opened end of the assembling space having an inner threaded section;
an interlocking ring having an outer threaded section corresponding to the inner threaded section of the assembling space and an inner surface with a strengthening surface treatment;
a chainring seat having a chamber assembled with a bearing piece for connection with the shaft, and an opened end of the chamber comprising an inner threaded section;
a shaft sleeve having a shaft hole jacketing onto the shaft, an outer threaded section, and a control section smaller than the outer threaded section with a strengthening surface treatment; and
a one-way bearing comprising an inner ring, an outer ring and a plurality of engaging blocks disposed between the inner and outer rings, an elastic piece disposed between the inner and outer rings, configured for restricting the engaging blocks, the one-way bearing mounted between the inner surface of the interlocking ring and the control section of the shaft sleeve.
